(19) United States
(12) Patent Application Publication
(10) Pub. No.: US 2002/0096811 A1
(43) Pub. Date: Jul. 25, 2002

(54) Knee pad

(76) Inventors: Kevin Callsen, Cleveland, OH (US); Gary Austin, Euclid, OH (US)

Correspondence Address: PEARNE & GORDON LLP, 526 SUPERIOR AVENUE EAST, SUITE 1200, CLEVELAND, OH, 44114-1484, US

(21) Appl. No.: 10/035,949

(22) Filed: Dec. 26, 2001

Related U.S. Application Data
(60) Provisional application No. 60/258,021, filed on Dec. 23, 2000.

(51) Int. Cl. F16F 3/00; A47C 27/00

(52) U.S. Cl. 267/145; 267/143

(57) ABSTRACT

A knee pad having a foam packet with a top and bottom layer of rubberized foam and a leak-resistant middle layer of polyurethane gel with pressure relief capabilities. The foam packet is enclosed within a bag with a top skin next to the knees that is a stretch nylon laminated to neoprene, so the knees will always be pressing against the foam packet, and a bottom skin that is a tear resistant material. KNEE PAD

This application claims the benefit of U.S. Provisional Application 60/258,021 filed Dec. 23, 2000.

### FIELD OF INVENTION

The present invention relates to cushioning pads or knee pads.

### BACKGROUND OF THE INVENTION

There is a need for a more innovative cushioning or knee pad to relieve or reduce pressure on the knees, so that kneeling comfort can be provided to an individual even after kneeling for long periods of time. However, such a kneeling pad still needs to be lightweight, durable, and easily maintained.

There are several types of kneeling pads to reduce or relieve pressure while kneeling. These knee pad devices can be categorized in three main groups: the traditional-style knee-mounted pad, the polyurethane closed or open cell foam knee pad mat, and the professional knee pad or mat.

The traditional-style knee pad has a hard shell backed with neoprene and a stitched or sewn cover using denier nylon. There are different variations of the traditional-style knee pad but they are generally held in place on the knee by nylon webbing using clips or Velcro. They may also be held in place by leather straps with laminate or carpet style pad padding. Although inexpensive and durable, such knee pads have several weaknesses. They seldom stay in place on the knee while the wearer is walking around. The straps may bind and pinch the back of the legs in the calf and thigh area. Furthermore, they are not very good at pressure relief or reduction.

Over the years, many companies have marketed polyurethane closed or open cell foam mats for knee protection and pressure reduction. Many companies market inexpensive foam mats made from all types of foam of various thickness and size and with screen print on them, but these types of mats are not designed for pressure reduction. Since the knees produce a pinpoint area of high pressure, these closed or open cell polyurethane or memory foam mats cannot produce the level of comfort needed when kneeling.

The professional knee pad or mat has a hard shell cover backed with a heat sealed packet of fluid material that is designed to imitate polyurethane gel to reduce knee pressure. These knee pads are very good at reducing knee pressure and kneeling comfort is maintained even after kneeling for long periods of time. However, the packet is not durable and may burst due to heavy use. Once the packet breaks, the fluid flows out of the packet and the knee pad can no longer reduce knee pressure. Furthermore, the professional knee-mounted pads have a strapping system, which may have similar problems as in the traditional-style knee pad of not staying in place on the knee while the wearer is walking around and pinching the back of the legs in the calf and thigh area.

### SUMMARY OF THE INVENTION

The present invention uses a combination of foam and polyurethane gel for knee pressure reduction and kneeling comfort. The cushioning pad consists of a thin, lightweight foam packet that has a top and bottom layer of rubberized foam and a leak-resistant middle layer of polyurethane gel with pressure relief capabilities. The foam packet is enclosed within a bag that is durable, but which also contributes to the kneeling comfort. The skin next to the knees is a 4-way stretch nylon laminated to neoprene, so the knees will always be pressing against the foam packet, maximizing the foam and gel combination underneath. The bottom skin is a tough cloth material so that it will be tear and abrasion resistant.

Further aspects and details of the present invention maybe had by referring to the following description and to the attached drawings.

### BRIEF DESCRIPTION OF THE DRAWINGS

FIG. 1 is a perspective view of a knee pad according to the present invention;

FIG. 2 is an exploded view of the knee pad according to FIG. 1; and

FIG. 3 is a cross-sectional view of the knee pad of FIG. 1 along line 3.

### DETAILED DESCRIPTION OF THE INVENTION

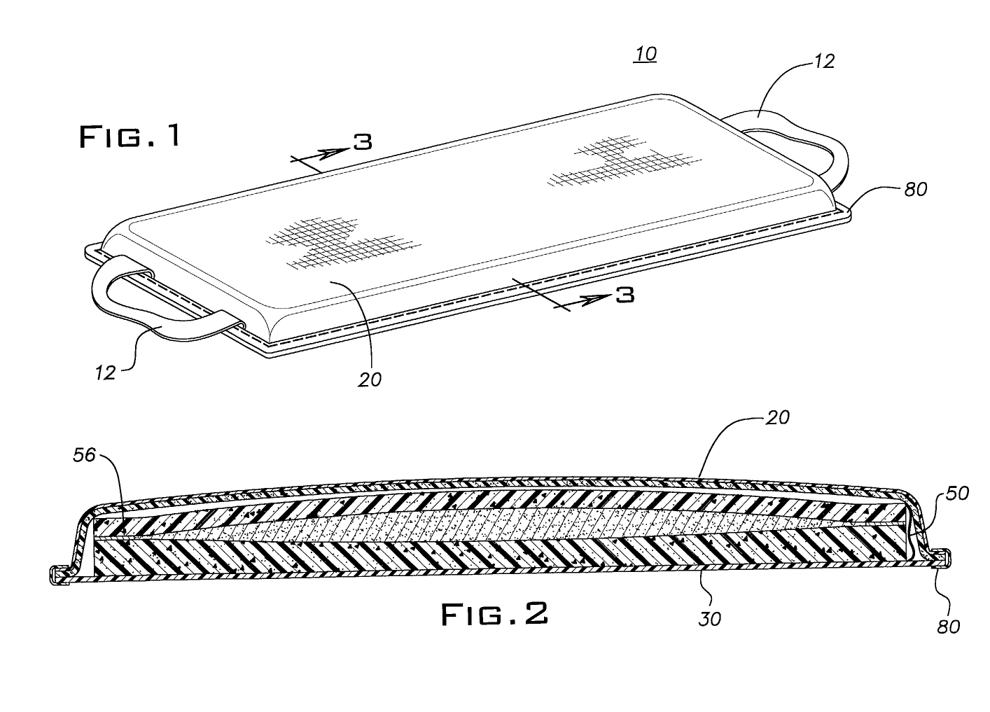

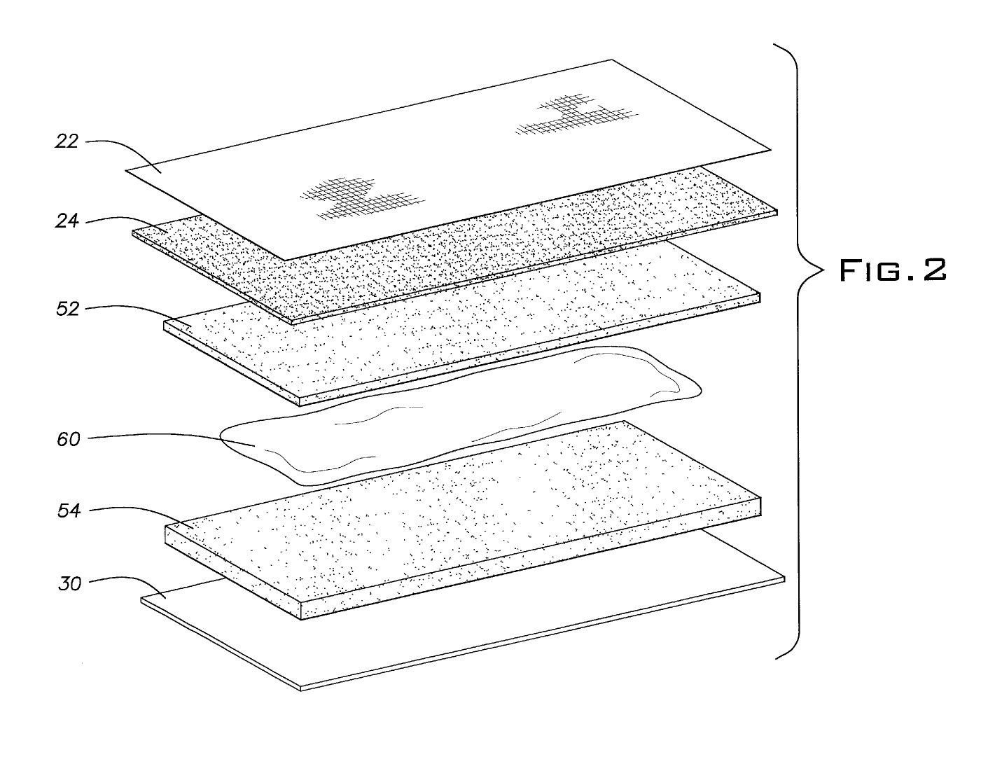

Referring to the drawings, FIG. 1 shows the exterior of a rectangular knee pad 10 according to the present invention with optional handles 12. FIGS. 2 and 3 show the knee pad 10 provided with a top skin 20, a bottom skin 30, and a foam packet 50. The foam packet includes a top layer 52, a bottom layer 54, and a layer of polyurethane gel 60.

The top skin 20 of the knee pad is made of a 4-way stretch nylon 22 and neoprene 24. The 4-way stretch nylon gives the pad durability. The 4-way stretch nylon also stretches in each direction for maximum pressure distribution, so the knees will always be pressing fully against the pad. The material is also oil resistant and may be screen printed. The 4-way stretch nylon 22 is laminated to neoprene 24, which allows the nylon to always return to its original shape. The neoprene also acts as another layer of padding and helps to envelop or surround the kneecap to give the kneeler another cushioning effect. The thickness of the neoprene is approximately one-sixteenth of an inch.

The bottom skin 30 of the knee pad is of a pack cloth material for durability. The material is tear resistant and oil resistant. Thus, the material will not break down for a significant amount of time, even with repeated contact with rough surfaces.

The top layer 52 of the foam packet is made of foam. The foam is rubberized closed cell foam, which is more dense than memory or urethane foams. The rubberization helps to make the foam resilient and the density helps for durability and pressure distribution in pinpoint pressure situations, thus helping to prevent bottoming out (i.e., where knees actually end up touching the ground). The thickness of the top foam layer is approximately one-fourth of an inch.

The bottom layer 54 of the foam packet is also made of foam, specifically rubberized closed cell foam. The foam is very resilient and the durability and feel helps prevent bottoming out. However, the bottom foam layer 54 may need to be thicker than the top foam layer 52 depending on how much polyurethane gel 60 is used. If more gel is used, then the thickness of the bottom foam layer may be reduced. The thickness of the bottom foam layer is approximately one-half of an inch. The extra one-quarter inch helps to prevent bottoming out.

The top foam layer 52 and the bottom foam layer 54 adhere at edge 56 of the foam packet to form a pocket for polyurethane gel 60. Unlike other gels or silicones, the polyurethane gel is cross-linked polyurethane. Thus, the polyurethane gel will not leak from the pad and will always retain its shape. The gel will also return to the original shape even after heavy repeated use.

The foam packet is formed by sealing or gluing the top foam layer 52 and the bottom foam layer 54 together at the edge 56, which forms a pocket between the two foam layers. A small section of the edge 56 is left unglued so there will be a small opening from the pocket to the outside of the foam layers. The polyurethane gel 60 is placed into the pocket through the small opening, after which the small opening is also sealed. The polyurethane gel will cure and adhere to the foam layers after a few minutes, thus forming a leak-resistant foam packet filled with gel. The foam packet may also by formed by sealing or gluing a thin bag made of polyurethane or other material between the two foam layers. A small section of the bag and the foam layers is left unsealed so as to leave a small opening in which to place the polyurethane gel into the thin bag. The small opening is then sealed and the polyurethane gel will cure and adhere to the bag after a few minutes.

The top skin 20 and bottom skin 30 are preferably sewn together like a flat bag along edge 80, which allows a person to stuff the bag with less time. The bag can be sewn with two edges, stuffed with the foam packet, and then sewn together. Therefore, the stitching will not contact the ground, which enables the knee pad to be more durable by not allowing the ground to tear the thread and eliminating the possibility that the stitching will come undone. The bag may have changeable color schemes for different companies and may also be screen printed for advertising. A handle 12 may also be sewn in the edge 80 of the bag so as to handle heavy repeated use. Different handle configurations may be made for different target markets. The handle may be made of strong nylon webbing or any other suitable material.

The present invention may be used in multiple markets and by multiple distributors. For example, the foam, gel and skin may be fire resistant as well as radiator coolant and motor and transmission oil resistant for certain applications. Entities that may make use of the present invention due to the feel and knee pressure reduction include body and repair shop employees, service and appliance repairmen, home and garden workers, construction companies, carpet layers and other floor installers, cement workers, manufacturers, home and business cleaners, health and fitness facilities, schools, churches, and any type of professional worker or person in the general population that may kneel when performing a task or activity.

Preferably, the present invention would be in a mat or pad form and be used for knee pressure reduction and kneeling comfort, but it can be modified to be in other pad forms, shapes, and sizes and may be used with straps or other fastener devices to attach to the user's knee. The present invention may also be used to relieve pressure on elbows, heels, hips and other pressure points while against a hard or abrasive surface.

While the invention has been described with reference to a specific embodiment, various changes may be made and equivalents may be substituted for elements thereof by those skilled in the art without departing from the scope of the invention. In addition, other modifications may be made to adapt a particular situation or method to the teachings of the invention without departing from the essential scope thereof. The present invention herein is not to be construed as being limited, except insofar as indicated in the appended claims.

What is claimed is:

1. A cushioning pad comprising:
a foam packet including a top layer of rubberized foam, a bottom layer of rubberized foam, and a leak-resistant middle layer of polyurethane gel; and
a top skin and bottom skin enclosing the foam packet.

2. A cushioning pad as in claim 1, wherein the polyurethane gel is a crossed linked polyurethane.

3. A cushioning pad as in claim 2, wherein the top skin is a stretch nylon connected to neoprene.

4. A cushioning pad as in claim 2, wherein the bottom skin is a tear resistant material.

5. A kneeling pad comprising:
a foam packet including a top layer of rubberized closed cell foam, a bottom layer of rubberized closed cell foam, and a middle layer of crossed linked polyurethane gel; and
a bag comprising a top skin and bottom skin enclosing the foam packet, wherein the top skin is a stretch nylon attached to neoprene and the bottom skin is a tear resistant material.

6. A kneeling pad as in claim 5, further comprising at least one handle connected to the bag.

7. A method of making a cushioning pad, which comprises:
sealing a top foam layer and a bottom foam layer together along an outer edge to form a pocket between the two foam layers with an opening at one end of the pocket;
placing leak-resistant polyurethane gel into the pocket through the opening;
sealing the opening to form a foam packet; and
enclosing the foam packet within a top skin of a stretch nylon attached to neoprene and a bottom skin of a tear resistant material.
